(19) United States
(12) Patent Application Publication
(10) Pub. No.: US 2026/0168930 A1
(43) Pub. Date: Jun. 18, 2026

(54) IN-SITU CHEMICAL IMAGING METHOD AND SYSTEM FOR SOIL EARTHWORM DRILOSPHERE

(71) Applicant: Zhejiang University, Hangzhou (CN)

(72) Inventors: Zhenyu QIANG, Hangzhou (CN); Dongxing GUAN, Hangzhou (CN)

(73) Assignee: Zhejiang University, Hangzhou (CN)

(21) Appl. No.: 19/383,771

(22) Filed: Nov. 10, 2025

Related U.S. Application Data
(63) Continuation of application No. PCT/CN2025/120009, filed on Sep. 9, 2025.

(30) Foreign Application Priority Data
Dec. 18, 2024 (CN) 2024118739223

(51) Int. Cl. G01N 21/64; G01N 21/78

(52) U.S. Cl. CPC G01N 21/6456; G01N 21/78

(57) ABSTRACT

An in-situ chemical imaging method for soil earthworm drilosphere includes: preparing an earthworm box and filling it with soil; selecting earthworms and placing them in the soil for cultivation to generate earthworm pores in the soil; sequentially arranging a filter membrane, a DGT binding gel, and a pH planar optode membrane on a soil profile of the earthworm drilosphere, ensuring the three membranes fully adhere to the soil profile; applying ultraviolet light under light-proof conditions, and cultivating for a period of time; capturing fluorescence signals emitted by the pH planar optode membrane to obtain a pH fluorescence image; performing a color development reaction on the DGT binding gel; capturing a color image of the color-developed DGT binding gel to obtain a DGT image; and performing image processing on the DGT image and pH fluorescence image to obtain spatial distribution images of labile phosphorus and pH in the earthworm drilosphere.

### TECHNICAL FIELD

The disclosure relates to the field of agricultural experiment technologies, and more particularly to an in-situ chemical imaging method and system for soil earthworm drilosphere.

### BACKGROUND

Phosphorus (P) is an essential nutrient element in soil, playing a critical role in enhancing crop yields, maintaining terrestrial ecosystem functions, and improving planetary health. Soil phosphorus includes inorganic and organic forms. Due to uneven agronomic practices and excessive cultivation, the level of the labile phosphorus in the soil has declined, which is detrimental to crop growth and soil health. The concept of “sustainable agriculture” emphasizes the importance of increasing phosphorus availability while maintaining agricultural ecosystem functions, and has been gradually applied in agricultural practice in recent years. Earthworms are ubiquitous soil fauna that have existed on Earth for more than 500 million years. They positively contribute to soil fertility and health improvement, nutrient cycling, and contaminant remediation through processes such as carbon stabilization. Because they critically shape the physical, chemical, and biological properties of the soil, the earthworms are regarded as “ecosystem engineers” (Vidal, A., Blouin, M., Lubbers, I., Capowiez, Y., Sanchez-Hernandez, J. C., Calogiuri, T., vanGroenigen, J. W., 2023. The role of earthworms in agronomy: Consensus, novel insights and remaining challenges, Advances in Agronomy. Academic Press, pp. 1-78). Therefore, enhancing the ecological role of earthworms is beneficial for increasing crop yield while maintaining fundamental ecosystem functions.

Earthworm-mediated phosphorus cycling has long been a subject of extensive research. For instance, Vos et al. investigated changes in labile phosphorus levels in casts of eight earthworm species and reference soil, finding that earthworm activity increased soil phosphorus availability (Vos, H. M. J., Koopmans, G. F., Beezemer, L., deGoede, R. G. M., Hiemstra, T., van Groenigen, J. W., 2019. Large variations in readily-labile phosphorus in casts of eight earthworm species are linked to cast properties. Soil Biology and Biochemistry 138, 107583). Van Groenigen et al. conducted a meta-analysis evaluating the role of earthworm casts in phosphorus activation, confirming the positive impact of earthworms on soil nutrient enhancement (Van Groenigen, J., Van Groenigen, K., Koopmans, G., Stokkermans, L., Vos, H., Lubbers, I., 2019. How fertile are earthworm casts? A meta-analysis. Geoderma 338, 525-535). The mechanisms behind earthworm-mediated phosphorus activation have been a focus of attention, primarily including: (1) Earthworms stimulate soil microbial activity, increasing phosphatase activity; (2) Microbial activity leads to the release of soluble organic matter, which then competes for adsorption sites with orthophosphate on clays and metal oxides, displacing inorganic phosphorus; (3) Earthworm activity alters soil potential of hydrogen (pH), thereby affecting phosphorus speciation and solubility (Vidal, A., Blouin, M., Lubbers, I., Capowiez, Y., Sanchez-Hernandez, J. C., Calogiuri, T., van Groenigen, J. W., 2023. The role of earthworms in agronomy: Consensus, novel insights and remaining challenges, Advances in Agronomy. Academic Press, pp. 1-78).

Although extensive research has been conducted on earthworm-mediated soil phosphorus activation processes using various chemical methods, the role of earthworms as drivers stimulating soil microbial activity—similar to roots in the rhizosphere and litter in the detritusphere—forms a microbial hotspot defined as the “earthworm drilosphere”. Due to the lack of reliable methods to study phosphorus biogeochemical processes in this unique soil environment, further exploration is still required (Kuzyakov Y, Blagodatskaya E, 2015. Microbial hotspots and hot moments in soil: Concept & review. Soil Biology and Biochemistry, 83:184-199). In-situ chemical imaging tools, including planar optode technology for in-situ monitoring of spatial pH changes in soil and the diffusive gradients in thin-films (DGT) technique for available chemical species, have been used to study biogeochemical processes in the rhizosphere and detritusphere, providing information on the spatial distribution of nutrient dynamics and pH. For example, Fang et al. used high-resolution zirconium-oxide DGT binding gels to assess phosphorus availability in the rice rhizosphere and the detritusphere (dead roots), thereby gaining insights into the spatial distribution and dynamics of phosphorus in these micro-environments (Fang, W., Williams, P. N., Zhang, H., Yang, Y., Yin, D., Liu, Z., Sun, H., Luo, J., 2021. Combining multiple high-resolution in situ techniques to understand phosphorous availability around rice roots. Environmental Science & Technology. 55, 13082-13092). Blossfeld et al. utilized planar optode technology to analyze the spatial dynamics of soil pH around wheat roots over time, providing a theoretical basis for nutrient migration and utilization by crop root systems (Blossfeld, S., Schreiber, C. M., Liebsch, G., Kuhn, A. J., Hinsinger, P., 2013. Quantitative imaging of rhizosphere pH and CO₂ dynamics with planar optodes. Annals of Botany 112, 267-276). However, DGT technology and planar optode technology have not yet been applied to the study of biogeochemical cycling in the earthworm drilosphere.

### SUMMARY

The disclosure aims to solve, at least to some extent, one of the technical problems in the related art mentioned above.

For this purpose, the disclosure provides an in-situ chemical imaging method and system for soil earthworm drilosphere, capable of solving the problem of difficulty in performing in-situ monitoring of biogeochemical cycling processes driven by earthworm activity in soil.

To address the above technical problem, the disclosure is implemented as follows.

An embodiment of the disclosure provides an in-situ chemical imaging method for soil earthworm drilosphere, and the in-situ chemical imaging method includes:
S1, preparing an earthworm box and filling the earthworm box with soil meeting requirements;
S2, selecting suitable earthworms, placing the earthworms in the soil within the earthworm box, and cultivating the earthworms for a period of time to allow formation of sufficient earthworm pores in the soil;
S3, sequentially arranging a filter membrane, a DGT binding gel (also referred to as DGT binding membrane), and a pH planar optode membrane on a soil profile of the earthworm drilosphere to be imaged, enabling the filter membrane, the DGT binding gel, and the pH planar optode membrane to fully adhere to the soil profile of the earthworm drilosphere, applying ultraviolet (UV) light to the earthworm box under light-proof conditions, and cultivating for a period of time; and capturing fluorescence signals emitted by the pH planar optode membrane using an imaging device to obtain a pH fluorescence image;
S4, performing a color development reaction on the DGT binding gel to obtain a color-developed DGT binding gel; and
S5, capturing a color image of the color-developed DGT binding gel using a flatbed scanner to obtain a DGT image, and performing image processing on the DGT image and the pH fluorescence image obtained in S3, to obtain a spatial distribution image of labile phosphorus in the earthworm drilosphere.

Furthermore, the in-situ chemical imaging method for the soil earthworm drilosphere according to the disclosure may also include the following additional technical features.

In some embodiments, the soil in S1 is soil with low or medium labile phosphorus content (the low or medium labile phosphorus content is in the range of 5 mg*kg⁻¹ to 40 mg*kg⁻¹ labile phosphorus).

In some embodiments, the soil in S1 has a moisture content of 60% to 70% of field water capacity.

In some embodiments, a certain amount of deionized water is supplemented between the pH planar optode membrane and the soil profile of the earthworm drilosphere to ensure no bubbles exist therebetween.

In some embodiments, the soil system is allowed to stand for at least 5 minutes after supplementing the deionized water between the pH planar optode membrane and the soil profile of the earthworm drilosphere to achieve complete stability of the soil system.

In some embodiments, the imaging device is equipped with a 370 nanometers (nm) band-pass filter in front to avoid interference from the excitation light with the fluorescence signals.

In some embodiments, the in-situ chemical imaging method further includes:
S6, establishing a labile phosphorus-gray value calibration curve and/or a pH-gray value calibration curve, and performing quantitative analysis on the imaging analysis results (i.e., the spatial distribution image of labile phosphorus in the earthworm drilosphere) using the established calibration curve(s).

In some embodiments, the performing a color development reaction on the DGT binding gel includes: peeling off the DGT binding gel after being attached to the soil profile of the earthworm drilosphere for 12 hours, rinsing off soil particles adhering to the surface of the DGT binding gel with deionized water, then immersing it in a molybdenum blue color development solution, reacting at 35° C. for 30 minutes, washing the reacted DGT binding gel with deionized water and drying the moisture with lint-free paper.

In some embodiments, the molybdenum blue color development solution is prepared by:
measuring a certain amount of concentrated sulfuric acid and slowly pouring it into a certain amount of deionized water, stirring uniformly to obtain solution A;
weighing a certain amount of ammonium molybdate and placing it in a certain amount of deionized water, heating and stirring to obtain solution B;
weighing a certain amount of potassium antimonyl tartrate and dissolving it in a certain amount of deionized water to obtain solution C;
mixing the solution A, the solution B, and the solution C uniformly, then diluting to a preset volume to obtain a color development stock solution; and
weighing a certain amount of ascorbic acid and dissolving it in a certain amount of the color development stock solution, then adding a certain amount of deionized water and mixing uniformly to obtain the molybdenum blue color development solution.

In some embodiments, in S2, the earthworms have a length of 3 cm, a quantity of 2 to 3 individuals, and a cultivation period of 7 days to 14 days.

The disclosure also provides an in-situ chemical imaging system for soil earthworm drilosphere, the in-situ chemical imaging system is configured to implement any one of the aforementioned in-situ chemical imaging methods for the soil earthworm drilosphere.

Compared with the prior art, the disclosure has at least the following beneficial effects.

In the embodiments of the disclosure, the provided in-situ chemical imaging method for the soil earthworm drilosphere is a soil in-situ chemical imaging technique for the earthworm drilosphere that combines DGT technology and pH planar optode technology, aiming to reveal the impact of earthworm activity on the spatial distribution characteristics of labile phosphorus and pH in soil.

In the embodiments of the disclosure, the provided in-situ chemical imaging method for the soil earthworm drilosphere enables in-situ monitoring of the nutrient cycling processes caused by earthworm activity in soil; unlike conventional chemical testing methods (which measure changes in soil mineral composition or content before and after adding earthworms), the disclosure conducts in-situ monitoring of the earthworm activity microzone (the area within approximately 2 mm of earthworm pores, also known as the earthworm drilosphere), i.e., directly performing imaging detection of nutrients and pH in key soil regions during earthworm activity.

In the embodiments of the disclosure, the provided in-situ chemical imaging method for the soil earthworm drilosphere enables visualization of biochemical reaction processes in the earthworm drilosphere; previous visualization methods for the earthworm drilosphere mainly reflected the potential extent of biochemical reactions but lacked quantitative analysis; the disclosure applies two chemical imaging technologies to this key soil region, the earthworm drilosphere, enabling visual monitoring of labile phosphorus content and pH values during earthworm activity, intuitively displaying the extent of biochemical reactions in this region, and performing quantitative analysis.

In the embodiments of the disclosure, the provided in-situ chemical imaging method for the soil earthworm drilosphere enables synchronous monitoring of multiple substances during the mineral-solution interface reaction process; through the combined use of DGT and pH planar optode technologies, synchronous monitoring of labile phosphorus and pH in this key region, the soil earthworm drilosphere, is achieved.

Additional aspects and advantages of the disclosure will be provided in part in the following description, will become apparent in part from the following description, or may be learned through practice of the disclosure.

### BRIEF DESCRIPTION OF DRAWINGS

FIG. 1 illustrates a front view of construction components of an earthworm box according to an embodiment of the disclosure.

FIG. 2 illustrates a side view of the construction components of the earthworm box according to an embodiment of the disclosure.

FIG. 3 illustrates a schematic diagram of a removable acrylic front plate and imaging system structure of the earthworm box according to an embodiment of the disclosure, showing, from top to bottom, a filter membrane, a DGT binding gel, a pH optode membrane, and a transparent acrylic plate, forming a layered structure positioned opposite soil profile for imaging.

FIG. 4 illustrates a schematic diagram of an earthworm box filled with soil and introduced with earthworms according to an embodiment of the disclosure.

FIG. 5A illustrates a labile phosphorus-gray value standard calibration curve according to an embodiment of the disclosure.

FIG. 5B illustrates a pH-gray value standard calibration curve according to an embodiment of the disclosure.

FIG. 6A illustrates a soil profile image of a low-phosphorus earthworm drilosphere (earthworm pore) according to an embodiment of the disclosure.

FIG. 6B illustrates a spatial distribution map of labile phosphorus diffusion flux of the low-phosphorus earthworm drilosphere according to an embodiment of the disclosure.

FIG. 7A illustrates a soil profile image of a medium-phosphorus earthworm drilosphere (earthworm pore) according to an embodiment of the disclosure.

FIG. 7B illustrates a spatial distribution map of labile phosphorus diffusion flux of the medium-phosphorus earthworm drilosphere according to an embodiment of the disclosure.

FIG. 8A illustrates a soil profile image of another medium-phosphorus earthworm drilosphere (earthworm pore) according to another embodiment of the disclosure.

FIG. 8B illustrates a spatial distribution map of labile phosphorus diffusion flux of another medium-phosphorus earthworm drilosphere according to another embodiment of the disclosure.

FIG. 8C illustrates a spatial distribution map of pH of another medium-phosphorus earthworm drilosphere according to another embodiment of the disclosure.

Reference Numerals: 1. removable acrylic front plate; 101. front plate screw; 102. front plate side hole; 103. imaging carrier plate; 104. front plate rear groove; 105. front plate screw hole; 106. pH planar optode membrane; 107. DGT binding gel; 108. front plate top screw hole; 2. removable acrylic top plate; 201. top plate screw; 202. ventilation hole; 203. top plate screw hole; 3. soil; 301. earthworm pore; 302. earthworm; 4. earthworm box rear portion; 401. earthworm box front screw hole; 402. earthworm box top screw hole; 5. electric wire; 6. thermohygrometer; 601. thermohygrometer display; 602. thermohygrometer sensor; 7. humidifier; 701. water pipe; 702. sprinkler head; 8. ventilation fan; 801. rotating shaft; 802. fan blade; 9. filter membrane.

### DETAILED DESCRIPTION OF EMBODIMENTS

The embodiments of the disclosure will be described below in conjunction with the accompanying drawings in a clear and complete manner. It should be understood that the described embodiments are only part of the embodiments of the disclosure, not all of them. All other embodiments obtained by those of ordinary skill in the art based on the embodiments of the disclosure without making creative efforts fall within the scope of protection of the disclosure.

The following describes the embodiments of the disclosure in detail through specific embodiments and application scenarios, with reference to the accompanying drawings.

To address the difficulty in performing in-situ monitoring of biogeochemical cycling processes driven by earthworm activity in soil, the disclosure provides an imaging system based on the DGT technique and pH planar optode technology. This system enables in-situ monitoring of soil labile phosphorus (labile-P) and pH within the earthworm drilosphere (the soil microzone influenced by earthworm activity), thereby facilitating in-situ analysis of soil biogeochemical processes mediated by earthworms. Unlike traditional pot-based soil sampling methods, the design of the disclosure overcomes potential alterations in soil physicochemical properties caused by destructive sampling. Furthermore, it significantly reduces monitoring time and costs in terms of operational and economic efficiency. Additionally, compared to the poor precision of traditional pot experiments, the disclosure achieves monitoring at a sub-millimeter scale, greatly enhancing monitoring precision.

In some embodiments of the disclosure, an in-situ chemical imaging method for the soil earthworm drilosphere is provided. The method primarily includes: (1) soil filling of the earthworm box; (2) earthworm cultivation; (3) attaching imaging membranes to the soil profile; (4) conducting chemical imaging experiments; and (5) image processing. The fundamental principles can be summarized as follows: (1) DGT: A high-resolution binding gel adsorbs soluble and exchangeable phosphorus from the soil over a defined period. The phosphorus content is then characterized using a molybdenum blue color development solution. Based on the gray values obtained from a scanner and the phosphorus standard calibration curve, the phosphorus content in various regions of the image is quantitatively analyzed. Furthermore, to accurately detect the labile-P content in the soil, the binding gel must have sufficiently small adsorbent particles (≤10 μm) that are uniformly distributed within the gel. (2) The surface of the pH optode membrane is coated with a fluorescent dye sensitive to pH changes. Under ultraviolet light excitation, H⁺ ions quench the fluorescence intensity. The combined use of these two imaging technologies enables the visualization and quantitative analysis of the spatial distribution of labile-P and pH in the soil. The specific technical solution is elaborated below.

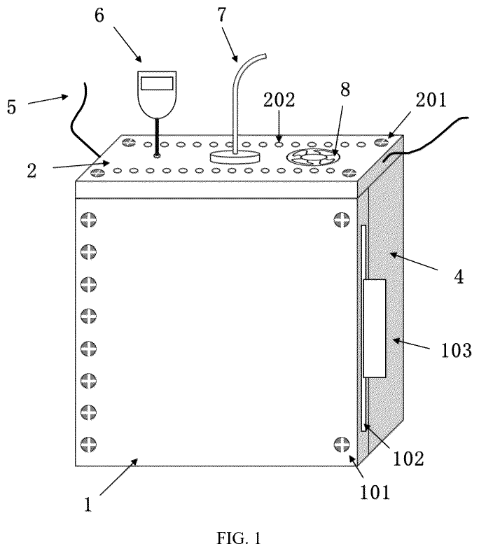

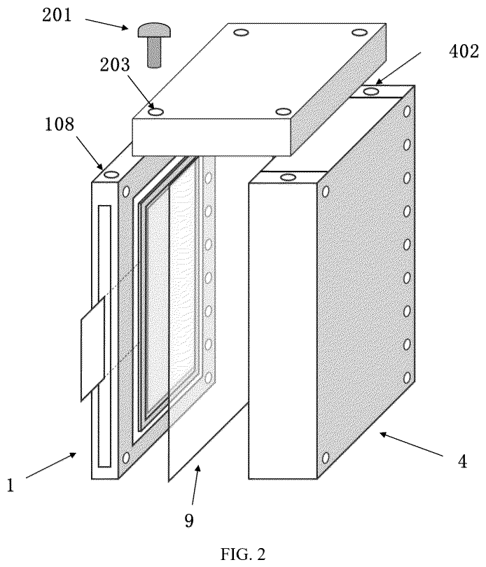

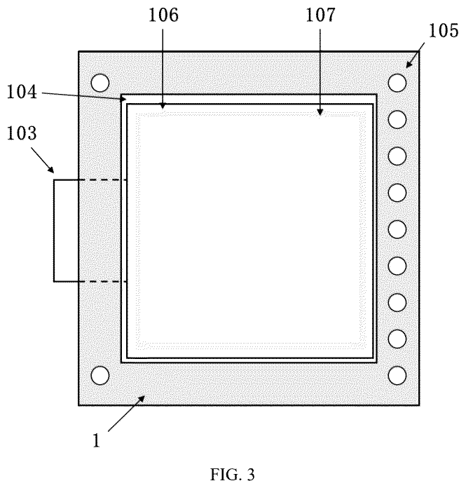

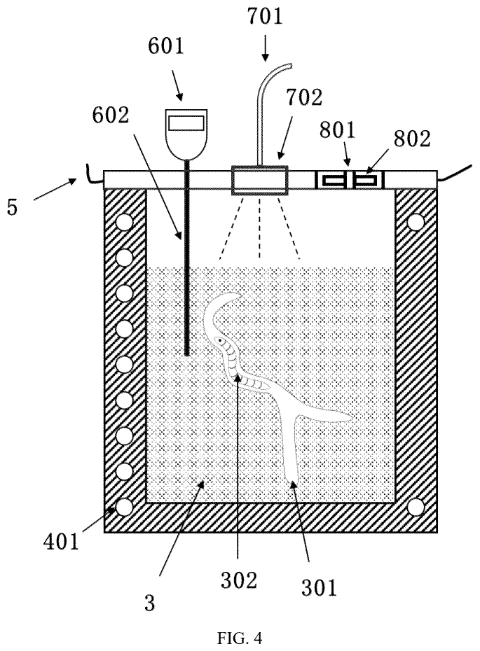

Step 1, earthworm box construction: to accommodate both the natural activity of earthworms and the attachment of monitoring membranes to the soil profile, please refer to FIGS. 1 to 4. A transparent acrylic square box (hereinafter referred to as the earthworm box) is designed as the container for earthworm activity. The earthworm box has a square box structure, primarily including a removable acrylic front plate 1, a removable acrylic top plate 2, an earthworm box rear portion 4, an electric wire 5, a thermohygrometer (i.e., temperature and humidity meter) 6, a humidifier 7, and a ventilation fan 8. On the removable acrylic front plate 1, front plate screws 101 are used to fix the removable acrylic front plate 1 to the earthworm box rear portion 4. The side of the removable acrylic front plate 1 is provided with front plate side holes 102 for inserting the imaging carrier plate 103; that is, the imaging carrier plate 103 is inserted into the front plate side holes 102. On the removable acrylic top plate 2, top plate screws 201 are used to fix the removable acrylic top plate 2 to the removable acrylic front plate 1 and the earthworm box rear portion 4. Several ventilation holes 202 are provided on the removable acrylic top plate 2 to allow air exchange between the inside of the earthworm box and the external environment. An end of the electric wire 5 is connected to a power supply, and the other end of the electric wire 5 is connected to the ventilation fan 8 to supply power to the ventilation fan 8. The thermohygrometer 6, humidifier 7, and ventilation fan 8 are all installed on the removable acrylic top plate 2. The thermohygrometer 6 includes a thermohygrometer display (i.e., display unit of the thermohygrometer) 601 and a thermohygrometer sensor (i.e., sensor of the thermohygrometer) 602. The thermohygrometer display 601 is located above the removable acrylic top plate 2, allowing external viewing of the current temperature and humidity readings. The thermohygrometer sensor 602 extends into the internal space of the earthworm box to measure the internal temperature and humidity. The humidifier 7 is used to periodically sprinkle water onto the soil to maintain soil moisture. The ventilation fan 8 is used to enhance air circulation inside the earthworm box. The top plate screw holes 203 and the front plate top screw holes 108 are connected and fixed by the top plate screws 201. The top wall of the earthworm box rear portion 4 is provided with earthworm box top screw holes 402. The top plate screw holes 203 and the earthworm box top screw holes 402 are connected and fixed by the top plate screws 201. A filter membrane 9 is vertically arranged between the removable acrylic front plate 1 and the earthworm box rear portion 4. The rear side of the removable acrylic front plate 1 is provided with a front plate rear groove 104, facilitating imaging after the pH planar optode membrane 106 and the DGT binding gel 107 on the imaging carrier plate 103 contact the soil 3. The front plate rear groove 104 is a groove machined inside the front plate and communicates with the soil inside the earthworm box. Soil fills the groove, providing sufficient space for the membranes to contact the soil. The order of the membranes used for soil imaging, from outside to inside, is the DGT binding gel 107 and the pH planar optode membrane 106. The front plate screw holes 105 and the earthworm box front screw holes 401 are fixed using the front plate screws 101.

In some embodiments of the disclosure, the humidifier 7 includes a water pipe 701 and a sprinkler head 702. The water pipe 701 is used to draw deionized water and transport it to the sprinkler head 702, which uniformly sprays the deionized water onto the surface of the soil 3. The ventilation fan 8 includes a rotating shaft 801 and fan blades 802, driven by the electricity transmitted through the electric wire 5, to ensure adequate oxygen levels inside the earthworm box.

Step 2, earthworm cultivation: slightly neutral, organic matter-containing soil 3 is selected as the substrate for earthworm cultivation. Before the earthworm box is filled with the soil, the soil must be pre-air-dried and passed through a 2 mm sieve. To further provide a soil environment suitable for earthworm growth, the soil moisture content needs to be adjusted to 60%-70% of the field water capacity using the humidifier 7 during or after filling, as determined by measurements from the thermohygrometer 6. The mature and active earthworms 302 are selected and cultivated in the soil 3. After 7 days to 14 days of cultivation, stable and sufficient earthworm pores 301 are formed. During the cultivation process, the periphery, top, and bottom sides of the earthworm box are wrapped with aluminum foil to simulate the dark environment within the soil. The aforementioned earthworm box is placed in a greenhouse maintained at 25° C. and 60% air humidity for cultivation.

Step 3, solution preparation:
Preparation of molybdenum blue color development solution: 194.6 mL of concentrated sulfuric acid is measured and slowly poured into 500 mL of deionized water, followed by stirring with a glass rod to prepare solution A. 20.00 g of ammonium molybdate is weighed, 200 mL of deionized water is added into the ammonium molybdate, following by heating and stirring to dissolve, to prepare solution B. 0.50 g of potassium antimonyl tartrate is weighed, and dissolved in 50 mL of deionized water, to prepare solution C. After the solutions A and B cool to room temperature, the solutions A, B, and C are mixed, diluted to 1000 mL with deionized water, transferred to a brown reagent bottle, following by storing protected from light, and at 4° C. in low temperature, this solution serves as a color development stock solution. 0.60 g of ascorbic acid is weighed and dissolved in 40 mL of the color development stock solution, then added with 400 mL of deionized water and mixed uniformly to obtain the molybdenum blue color development reagent for phosphorus.

Step 4, imaging system construction: the filter membrane 9, the DGT binding gel 107, and the pH planar optode membrane 106 are sequentially attached onto the soil profile containing earthworm pores. A plastic spacer is inserted between the pH planar optode membrane and the imaging carrier plate 103 to ensure the aforementioned membranes closely adheres to the soil profile, thereby improving the reliability of solute imaging by the high-resolution DGT binding gel and the pH planar optode membrane. During the experimental period, the optimal deployment time for the DGT binding gel and the pH planar optode membrane also needs to be determined. Captured images are processed using ImageJ software, and the spatial resolution of the DGT and pH planar optode images is confirmed. The filter membrane, serving as part of the diffusive layer in the DGT device and also reducing radial diffusion to maintain stable diffusion and adsorption of solutes, is purchased from Whatman (Nucleopore Track-Etch Membrane, pore size 0.2 μm). The high-resolution DGT binding gel for labile-P enrichment is purchased from Nanjing Weisen Environmental Technology Co., Ltd., model: precipitated zirconium oxide binding gel (GDZR), thickness 0.1 mm. The pH planar optode membrane is sourced from Zhongke Zhigan (Nanjing) Environmental Technology Co., Ltd. After the reaction period, the DGT gel and the pH planar optode membrane are imaged separately. (a) DGT gel imaging: the high-resolution DGT binding gel is peeled off after being attached to the soil profile for 12 hours, rinsed with deionized water to remove adhering soil particles, immersed in the molybdenum blue color development solution, reacted at 35° C. for 30 minutes, then washed with deionized water, dried with lint-free paper, and scanned on a flatbed scanner to obtain the color-developed image. (b) pH optode membrane imaging: the pH optode membrane is attached to the soil profile. To avoid bubbles between the membrane and the soil profile, a small amount of deionized water can be supplemented between them, and the system is left to stand for 5 minutes to achieve complete stability of the soil system. The earthworm box is placed in front of a planar UV light source with a wavelength of 355 nm. A camera is used to capture the fluorescence signals emitted by the pH optode membrane. A 370 nm band-pass filter is placed in front of the camera lens to filter out the UV light and prevent it from interfering with the fluorescence signals from the pH optode membrane.

Step 5, standard calibration curves for quantitative analysis of the image processing results are established;

The imaging displays the two-dimensional distribution of labile-P and pH across all pixels within the membrane area, rather than just obtaining the average concentration in the region or concentration changes along a single dimension. Without standard calibration curves, the data presented are merely gray values identified by the software. The experimental results become meaningful only after correction and analysis using the standard calibration curves.

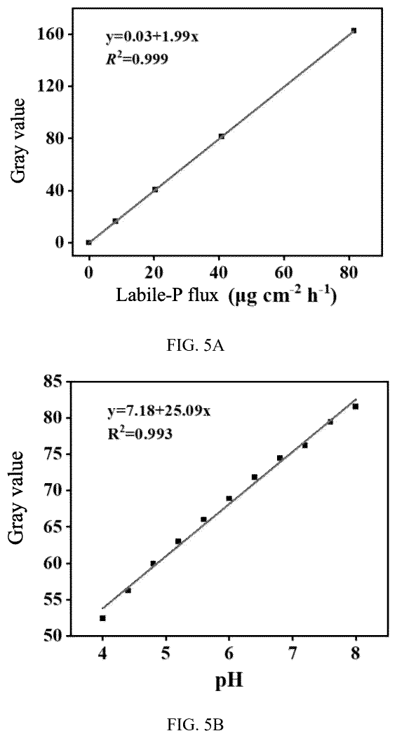

Please refer to FIG. 5A and FIG. 5B, FIG. 5A shows the labile-P-gray value standard calibration curve. Phosphorus standard solutions with concentrations of 0, 20, 50, 100, 200, 500, 750, 1000, and 2000 μg*L⁻¹ are prepared using a phosphorus standard reference material. Disc-shaped DGT gels are placed into the phosphorus solutions, adsorbed for 12 hours, and then subjected to color development in the molybdenum blue color development solution. The colored DGT gels are immediately rinsed several times with 4° C. deionized water to remove residual color development reagent from their surfaces, and then soaked in deionized water for another 5 minutes (to stop the color development reaction). The DGT gels are taken out, surface water is wiped off with filter paper, and the DGT gels are placed on a scanner (face down). The resolution is set to 1200 dots per inch (dpi). After scanning to obtain the image, ImageJ software is used to convert the image to grayscale. The exponential function with the highest correlation is selected to fit the accumulated P amount per unit area on the gel and its corresponding grayscale intensity of the gel surface, resulting in the standard calibration curve of analyte accumulation per unit area (f) versus grayscale value (G), i.e., G(f). FIG. 5B shows the pH-gray value standard calibration curve: pH standard solutions are prepared using sodium acetate-acetic acid solutions (pH 4 to 6) and potassium dihydrogen phosphate-borax solutions (pH 6 to 9). A strip-shaped standard pH optode membrane is placed in a cuvette and submerged with deionized water to ensure complete contact with the cuvette. Then, standard solutions representing different pH values are sequentially poured into the cuvette. After each addition, the cuvette is exposed to 355 nm ultraviolet light to induce color development, and the resulting fluorescence intensity is recorded using a camera equipped with a front-mounted band-pass filter. ImageJ software is used to measure the intensity values and draw the standard calibration curve. Using the “Calibration bar” function option in the ImageJ software, scales for labile-P concentration and pH value are inserted into the imaging figures.

### Embodiment 1: Visualization of Spatial Distribution of Labile-P in a Low-Phosphorus Soil Earthworm Drilosphere

(1) Earthworm cultivation: low-phosphorus soil (labile-P content is 8.75 mg*kg⁻¹) is filled into the designed earthworm box. Three individuals of Eisenia fetida earthworms, each 3 cm in length and 0.5 g in weight, are selected and cultivated in the earthworm box for 7 days to generate sufficient earthworm pores. During the cultivation process, the earthworm box is wrapped with aluminum foil to simulate the dark soil environment. The earthworm box is placed in a greenhouse maintained at 25° C. and 60% air humidity for cultivation. An appropriate amount of water is periodically sprinkled onto the surface through the top opening during cultivation to maintain soil moisture.

(2) Material preparation: high-resolution DGT binding gels are cut into discs with a diameter of 2.5 cm for immersion and adsorption of phosphorus standard solutions to establish the labile-P concentration-gray value standard calibration curve. Several DGT binding gels with dimensions of 5 cm×5 cm are also cut for attaching to the drilosphere profile for labile-P spatial distribution imaging. Filter membranes slightly larger than the imaging gels are prepared to maintain the stability of the soil-solution interface. Phosphorus standard solutions with a certain concentration gradient and the molybdenum blue color development solution are prepared for subsequent reaction and color development of the standard phosphorus binding gels and the imaging gels.

(3) Imaging operation: after the cultivation period, the removable acrylic front plate of the earthworm box is taken off. The filter membrane is attached to the target soil profile for imaging, and the high-resolution DGT binding gel is placed on the imaging carrier plate. The acrylic front plate is then covered, and the imaging carrier plate is inserted. To ensure tight contact between the acrylic plate and the DGT binding gel, a plastic sheet is inserted between the DGT binding gel and the imaging carrier plate, ensuring the DGT binding gel and the filter membrane fully adhered to the soil profile. After deployment in the dark for 12 hours, the imaging carrier plate is removed. The DGT binding gel is peeled off, its surface is rinsed with deionized water, and then the DGT binding gel is reacted in the molybdenum blue color development solution for 30 minutes. After rinsing off residual color development solution from the surface of the DGT binding gel with deionized water, the color image is captured using a flatbed scanner. Imaging of the standard phosphorus binding gels is performed using the same method.

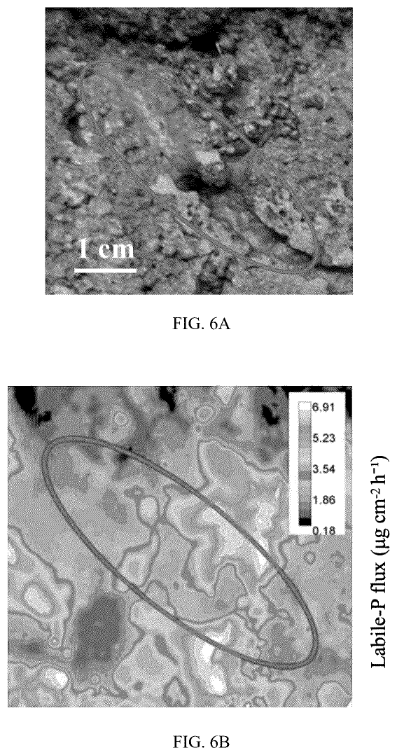

(4) Image processing: the captured images are imported into ImageJ and converted into 8-bit grayscale images. Appropriate pseudo-colors are applied to the grayscale images, where the displayed pseudo-colors corresponded one-to-one with the grayscale values (i.e., gray values). By mapping the labile-P concentration values to the pseudo-colors displayed on the image using the calibration curve, the spatial distribution image of labile-P in the earthworm drilosphere is obtained, as shown in FIG. 6A and FIG. 6B.

### Embodiment 2: Visualization of Spatial Distribution of Labile-P in Medium-Phosphorus Soil Earthworm Drilosphere

(1) Earthworm cultivation: medium-phosphorus soil (labile-P content is 40 mg*kg⁻¹) is filled into the designed earthworm box. Three individuals of Eisenia fetida earthworms, each 3 cm in length and 0.5 g in weight, are selected and cultivated in the earthworm box for 7 days to generate sufficient earthworm pores. During the cultivation process, the earthworm box is wrapped with aluminum foil to simulate the dark soil environment. The earthworm box is placed in a greenhouse maintained at 25° C. and 60% air humidity for cultivation. An appropriate amount of water is periodically sprinkled onto the surface through the top opening during cultivation to maintain soil moisture.

(2) Material preparation: high-resolution DGT binding gels are cut into discs with a diameter of 2.5 cm for immersion and adsorption of phosphorus standard solutions to establish the labile-P concentration-gray value standard calibration curve. Several high-resolution DGT binding gels with dimensions of 5 cm×5 cm are also cut for attaching to the drilosphere profile for labile-P spatial distribution imaging. Filter membranes slightly larger than the imaging gels are prepared to maintain the stability of the soil-solution interface. Phosphorus standard solutions with a certain concentration gradient and the molybdenum blue color development solution are prepared for subsequent reaction and color development of the standard phosphorus binding gels and the imaging gels.

(3) Imaging operation: after the cultivation period, the removable acrylic front plate of the earthworm box is taken off. The filter membrane is attached to the target soil profile for imaging, and the high-resolution DGT binding gel is placed on the imaging carrier plate. The acrylic front plate is then covered, and the imaging carrier plate is inserted. To ensure tight contact between the acrylic plate and the DGT binding gel, a plastic sheet is inserted between the DGT binding gel and the imaging carrier plate, ensuring the DGT binding gel and the filter membrane fully adhered to the soil profile. After deployment in the dark for 12 hours, the imaging carrier plate is removed. The DGT binding gel is peeled off, its surface is rinsed with deionized water, and then the DGT binding gel is reacted in the molybdenum blue color development solution for 30 minutes. After rinsing off residual color development solution from the surface of the DGT binding gel with deionized water, the color image is captured using a flatbed scanner. Imaging of the standard phosphorus binding gels is performed using the same method.

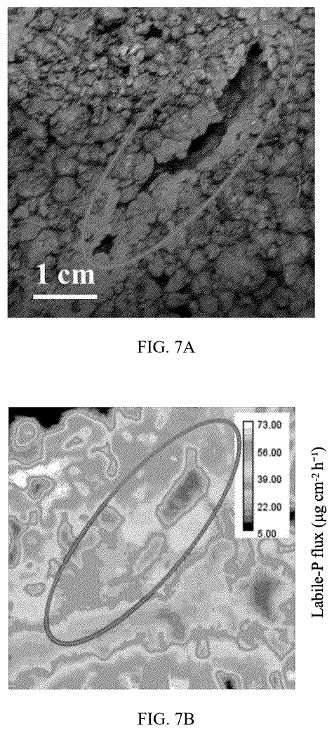

(4) Image processing: the captured images are imported into ImageJ and converted into 8-bit grayscale images. Appropriate pseudo-colors are applied to the grayscale images, where the displayed pseudo-colors corresponded one-to-one with the grayscale values. By mapping the concentration values of the fluorescent substance and the labile phosphorus concentration to the pseudo-colors displayed on the image using the calibration curves, the distribution images of phosphatase and labile-P at the interface are obtained, as shown in FIG. 7A and FIG. 7B.

### Embodiment 3: Visualization of Spatial Distribution of pH and Labile-P In Medium-Phosphorus Soil Earthworm Drilosphere

(1) Earthworm cultivation: medium-phosphorus soil (labile-P content is 40 mg*kg⁻¹) is filled into the designed earthworm box. Three individuals of Eisenia fetida earthworms, each 3 cm in length and 0.5 g in weight, are selected and cultivated in the earthworm box for 7 days to generate sufficient earthworm pores. During the cultivation process, the earthworm box is wrapped with aluminum foil to simulate the dark soil environment. The earthworm box is placed in a greenhouse maintained at 25° C. and 60% air humidity for cultivation. An appropriate amount of water is periodically sprinkled onto the surface through the top opening during cultivation to maintain soil moisture.

(2) Material preparation: (a) A standard pH optode membrane with dimensions of 1 cm×3 cm is cut for immersion and imaging in pH standard solutions, and the pH standard solutions with a certain concentration gradient are prepared. After immersing the aforementioned pH optode membrane in the standard solutions for 5 minutes, it is excited and imaged under 355 nm ultraviolet light. The fluorescence images are captured using a camera equipped with a front-mounted 370 nm band-pass filter. Additionally, a pH optode membrane sized 5 cm×5 cm is cut and attached to the imaging carrier plate, ensuring full contact with the soil profile, for in-situ monitoring of the spatial distribution of pH of the soil profile. (b) DGT binding gels are cut into discs with a diameter of 2.5 cm for immersion and adsorption of phosphorus standard solutions to establish the labile-P concentration-gray value standard calibration curve. Several square DGT binding gels with dimensions of 5 cm×5 cm are also cut for attaching to the drilosphere profile for labile-P spatial distribution imaging. Filter membranes slightly larger than the imaging gels are prepared to maintain the stability of the soil-solution interface. Phosphorus standard solutions with a certain concentration gradient and the molybdenum blue color development solution are prepared for subsequent reaction and color development of the standard phosphorus binding gels and the imaging gels.

(3) Imaging operation: after the cultivation period, the removable acrylic front plate of the earthworm box is taken off. The filter membrane is attached to the target soil profile for imaging. Then, the pH optode membrane and the square DGT binding gel are sequentially placed on the imaging carrier plate. A plastic sheet is inserted between the pH optode membrane and the imaging carrier plate. The acrylic front plate is then covered, and the imaging carrier plate is inserted into the acrylic front plate, ensuring the pH optode membrane, DGT binding gel, and filter membrane fully adhered to the soil profile. After deployment in the dark for 12 hours, the earthworm box is first placed directly under a UV lamp for in-situ pH imaging. Subsequently, the imaging carrier plate is removed. The pH optode membrane and the DGT binding gel are peeled off. The surface of the DGT binding gel is rinsed with deionized water, reacted in the molybdenum blue color development solution for 30 minutes, and rinsed again to remove residual color development solution, and then the color image is captured using a flatbed scanner. Imaging of the standard phosphorus binding gels is performed using the same method. The pH planar optode membrane is imaged under 355 nm ultraviolet light, and the fluorescence image is captured using a camera with a front-mounted filter.

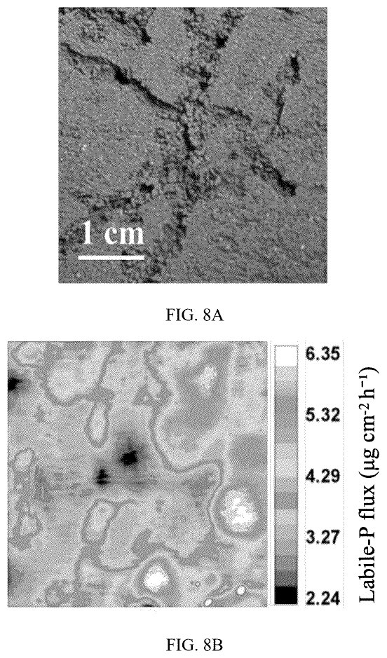

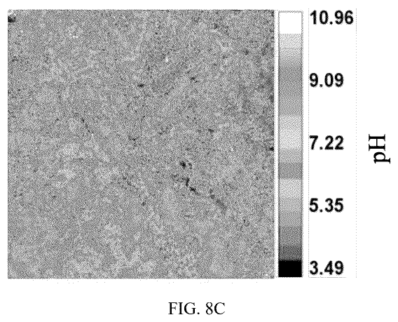

(4) Image processing: the captured images are imported into ImageJ and converted into 8-bit grayscale images. Appropriate pseudo-colors are applied to the grayscale images, where the displayed pseudo-colors corresponded one-to-one with the grayscale values. By mapping the concentration values of the fluorescent substance and the labile-P concentration to the pseudo-colors displayed on the image using the calibration curves, the distribution images of pH value and labile-P at the interface are obtained, as shown in FIG. 8A, FIG. 8B and FIG. 8C.

Although the combined use of planar optodes and DGT is currently widely applied for in-situ monitoring of the spatial distribution of solutes (e.g., heavy metals) in the rhizosphere soil, there are fundamental differences between the rhizosphere environment and the earthworm drilosphere environment. These include differences in the growth environments of plants and earthworms, differences in the impact of plant roots versus earthworms on soil nutrient cycling, and differences in the microzones formed by root growth versus earthworm movement. Specifically:
1) Plant growth relies on substantial soil water to supply plant metabolism. Particularly, rice plants depend more on waterlogged soil environments, where soil moisture reaches or exceeds 100%. However, earthworm activity generally requires soil moisture between 60% and 70% or even lower, as earthworms struggle to survive in overly wet soil.
2) The plant rhizosphere plays a crucial role during plant growth, such as absorbing mineral nutrients from the soil. Consequently, nutrient element content in the rhizosphere is often lower than in bulk soil. In contrast, earthworm activity (e.g., secreting coelomic fluid and excreting casts) directly increases nutrient content in the drilosphere soil on one hand, and promotes soil nutrient activation by providing resources for soil microorganisms on the other hand.
3) Root growth is relatively fixed, whereas earthworm activity is random, leading to the disordered formation of earthworm pores.

Therefore, the advantages and characteristics of the disclosure are reflected in the following aspects:
1) Devices used in traditional soil in-situ imaging technologies for soil-plant systems are often semi-open to facilitate plant growth. However, this design is unsuitable for the earthworm drilosphere soil system involving earthworm activity, as it can lead to earthworm escape and consequently reduce the number of stable earthworm pores within the device. Therefore, unlike rhizoboxes, the device for soil in-situ imaging technology in the disclosure incorporates the removable acrylic top plate to prevent earthworm escape during soil cultivation.
2) Devices used in traditional soil in-situ imaging technologies for soil-plant systems under waterlogged conditions often involve soil water content reaching or exceeding 100%. However, this growth environment is not suitable for earthworm cultivation. To better simulate a soil environment suitable for earthworm growth, the device of the disclosure is equipped with a thermohygrometer and a humidification device (i.e., humidifier) on the removable acrylic top plate, allowing for real-time regulation of soil moisture content to ensure the normal survival of earthworms.
3) Unlike traditional soil in-situ imaging devices, to further facilitate operation, the device of the disclosure defines a rear groove on the removable acrylic front plate and houses a movable imaging carrier plate, making it convenient to promptly replace the pH planar optode membrane and the DGT binding gel.

Parts not described in detail in the disclosure may be implemented with reference to the related art in the field or techniques known to those skilled in the art, and no further explanation is provided here.

The embodiments of the disclosure have been described above in conjunction with the accompanying drawings. However, the disclosure is not limited to the specific embodiments described above, which are merely illustrative and not restrictive. Under the guidance of the disclosure, those of ordinary skill in the art may make various modifications without departing from the spirit and scope of the disclosure as defined by the appended claims. All such modifications fall within the protection scope of the disclosure.

What is claimed is:

1. An in-situ chemical imaging method for soil earthworm drilosphere, comprising:
S1, preparing an earthworm box and filling the earthworm box with soil meeting requirements; wherein the soil has a moisture content of 60% to 70% of field water capacity;
S2, selecting suitable earthworms, placing the earthworms in the soil within the earthworm box, and cultivating for a period of time to allow formation of sufficient earthworm pores in the soil;
wherein the earthworm box has a square box structure, comprising a removable acrylic front plate (1), a removable acrylic top plate (2), and an earthworm box rear portion (4); the removable acrylic front plate (1) is fixed to the earthworm box rear portion (4) via front plate screws (101); the removable acrylic top plate (2) is fixed to the removable acrylic front plate (1) and the earthworm box rear portion (4) via top plate screws (201); and a top wall of the earthworm box rear portion (4) is provided with earthworm box top screw holes (402), and top plate screw holes (203) are connected and fixed to the earthworm box top screw holes (402) via the top plate screws (201);
wrapping peripheral sides, top, and bottom sides of the earthworm box with aluminum foil;
S3, sequentially arranging a filter membrane, a diffusive gradients in thin-films (DGT) binding gel, and a potential of hydrogen (pH) planar optode membrane on a soil profile of the earthworm drilosphere to be imaged, enabling the filter membrane, the DGT binding gel, and the pH planar optode membrane to fully adhere to the soil profile of the earthworm drilosphere, applying ultraviolet light to the earthworm box under light-proof conditions, cultivating for a period of time, and capturing fluorescence signals emitted by the pH planar optode membrane using an imaging device to obtain a pH fluorescence image; wherein a certain amount of deionized water is supplemented between the pH planar optode membrane and the soil profile of the earthworm drilosphere to ensure no bubbles exist therebetween, and a soil system is allowed to stand for at least 5 minutes after supplementing the deionized water to achieve complete stability of the soil system;
S4, performing a color development reaction on the DGT binding gel to obtain a color-developed DGT binding gel; and
S5, capturing a color image of the color-developed DGT binding gel using a flatbed scanner to obtain a DGT image, and performing image processing on the DGT image and the pH fluorescence image obtained in S3, to obtain spatial distribution images of labile phosphorus and pH in the earthworm drilosphere.

2. The in-situ chemical imaging method according to claim 1, wherein the soil in S1 is soil with low or medium labile phosphorus content.

3. The in-situ chemical imaging method according to claim 1, wherein the imaging device is equipped with a 370 nm band-pass filter in front to avoid interference of the ultraviolet light with the fluorescence signals.

4. The in-situ chemical imaging method according to claim 1, further comprising:
S6, establishing at least one of a labile phosphorus-gray value calibration curve and a pH-gray value calibration curve, and performing quantitative analysis on imaging analysis results using the at least one of the labile phosphorus-gray value calibration curve and the pH-gray value calibration curve.

5. The in-situ chemical imaging method according to claim 1, wherein the performing a color development reaction on the DGT binding gel comprises: peeling off the DGT binding gel after being attached to the soil profile of the earthworm drilosphere for 12 hours, rinsing off soil particles adhering to a surface of the DGT binding gel with deionized water, then immersing the DGT binding gel in a molybdenum blue color development solution, and reacting at 35°C. for 30 minutes to obtain a reacted DGT binding gel, followed by washing the reacted DGT binding gel with deionized water and drying moisture with lint-free paper.

6. The method according to claim 5, wherein the molybdenum blue color development solution is prepared by:
measuring a certain amount of concentrated sulfuric acid and slowly pouring the concentrated sulfuric acid into a certain amount of deionized water, stirring uniformly to obtain solution A;
weighing a certain amount of ammonium molybdate and placing the ammonium molybdate in a certain amount of deionized water, heating and stirring to obtain solution B;
weighing a certain amount of potassium antimonyl tartrate and dissolving the potassium antimonyl tartrate in a certain amount of deionized water to obtain solution C;
mixing the solution A, the solution B, and the solution C uniformly, then diluting to a preset volume to obtain a color development stock solution; and
weighing a certain amount of ascorbic acid and dissolving the ascorbic acid in a certain amount of the color development stock solution, then adding a certain amount of deionized water and mixing uniformly to obtain the molybdenum blue color development solution.

7. An in-situ chemical imaging system for soil earthworm drilosphere, configured to implement the in-situ chemical imaging method according to claim 1.
